(19) United States
(12) Patent Application Publication
(10) Pub. No.: US 2002/0135563 A1
(43) Pub. Date: Sep. 26, 2002

(54) Enabling manual adjustment of pointing device cursor speed

(76) Inventor: Sri K. Canakapalli, American Fork, UT (US)

Correspondence Address: Timothy N. Trop, TROP, PRUNER & HU, P.C., STE 100, 8554 KATY FWY, HOUSTON, TX, 77024-1805, US

(21) Appl. No.: 09/817,719

(22) Filed: Mar. 26, 2001

(51) Int. Cl. G09G 5/08

(52) U.S. Cl. 345/163

(57) ABSTRACT

A pointing device, such as a mouse, may include a speed control that allows the user to input commands that adjust the rate at which the cursor moves in response to pointing device movements. In particular, the user can manually input speed increases or speed reductions as the pointing device is being manipulated. For example, in connection with a mouse, a speed control button may be provided on the mouse body at a location normally adjacent to the user's thumb. Thus, by simple thumb manipulation, the user can dynamically adjust the speed at which the cursor moves in response to mouse movement.

### BACKGROUND

This invention relates generally processor-based systems and particularly to pointing devices, such as the mouse, for controlling the position of an on-screen cursor.

Conventionally, a mouse is utilized in processor-based systems to enable the user to supply input commands. The user can move the mouse in the user's hand to adjust the position of an on-screen cursor. Various options or icons displayed on screen may then be selected by operating mouse buttons.

Conventionally, the cursor moves on the screen at speed which is generally the same as the speed at which the user moves the mouse. Thus, there is a convenient symmetry between hand and cursor movements.

However in some cases, especially when large movements are needed, the ability to use software is limited by the mouse speed. For example, in a number of situations, slow cursor control movements may be problematic. In other words, the user may be able to input data at a quicker rate if the mouse cursor moved more quickly.

In a number of different software routines, there are settings which control the rate of cursor movement with respect to the rate of mouse movement in the user's hand. These settings enable global, persistent adjustment of the speed of movement of the cursor.

However, there is a need for more adjustability in the way that cursors respond to pointing device movements.

### BRIEF DESCRIPTION OF THE DRAWINGS

FIG. 1 is a perspective view of a mouse in accordance with one embodiment of the present invention;

FIG. 2 is a block diagram of the mouse shown in FIG. 1;

FIG. 3 is a block diagram of a processor-based system using the mouse shown in FIG. 2 in accordance with one embodiment of the present invention; and

FIG. 4 is a flow chart for software used in accordance with one embodiment of the present invention.

### DETAILED DESCRIPTION

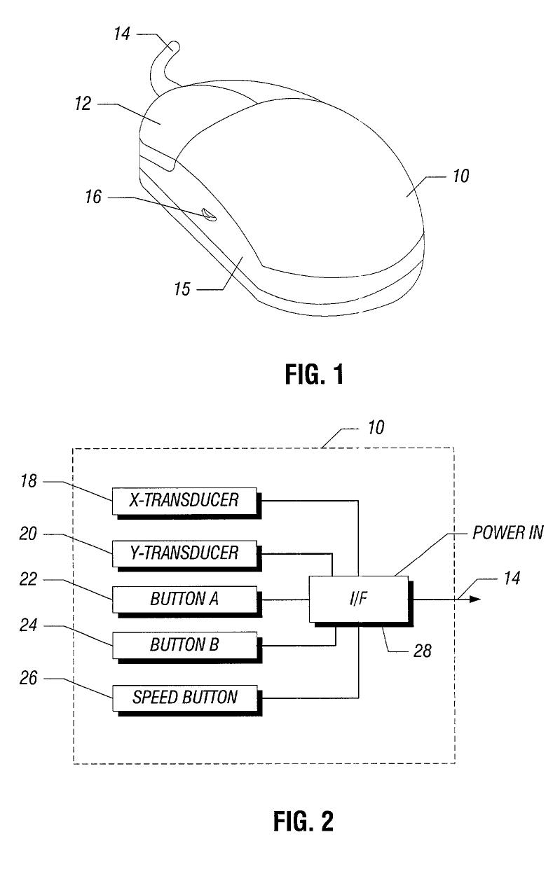

Referring to FIG. 1, a pointing device 10, such as mouse, may include at least one button 12 and a cable 14 that is conventionally a Universal Serial Bus or other serial interface cable that couples a pointing device to a processor-based system. The body 15 has a side wall 13 that includes a control 16. When the user grasps the pointing device 10 in the palm of the user's hand, the user's thumb may conveniently be positioned atop the control 16. That is, in normal use, the user's thumb tends to rest on the side wall 13. The control 16 may be positioned so as to be under the user's thumb when the user's hand is positioned conventionally on the pointing device 10 in one embodiment.

In one embodiment, the control 16 allows “on-the-fly” speed control inputs to control the rate at which the cursor moves in response to pointing device 10 movements. For example, the user can actuate the control 16 to increase the speed of cursor movements for corresponding pointing device 10 movements and actuate the button 16 otherwise to reduce the cursor speed. For example, the user can use his or her thumb to make ongoing adjustments in cursor speed response characteristics.

In one embodiment, the control 16 may be a roller whose direction of movement selectively increases or decreases the cursor speed. The control 16 may be implemented in a variety of different forms. The control 16 may include a pair of up and down pushbuttons, a rocker button, a joy stick, a tilt switch, or even a pressure responsive switch, to mention a few examples. In general, any control 16 that enables the user to adjust the speed of cursor movements “on-the-fly” in the course of operating the pointing device 10 may be useful in some embodiments of the present invention.

Referring to FIG. 2, the pointing device 10 may include an interface that serializes input commands in one embodiment. For example, the interface 28 may receive x and y transducer commands, indicative of the direction of movement of the device 10, and, at least indirectly, the rate of speed of movement of the mouse 10. Thus, signals from the x transducer 18 and y transducer 20 may be coupled through the interface 28 to the cable 14. Likewise, signals from a button 12 may be received as indicated at 22 as well as signals from a second button as indicated at 24. All these signals may be converted to an appropriate format and sent on to a processor-based system by the interface 28. Similarly, inputs from the control 16 may be transferred, as indicated at 26, through the interface 28 to the cable 14.

The interface 28 may also receive power from a processor-based system as indicated at “power in”. In one embodiment, the power may be received over the cable 14.

Thus, conventional mouse command signals in one of a variety of conventional formats may be transferred together with the speed commands, indicated at 26, from the interface 28 to a processor-based system (not shown in FIG. 2).

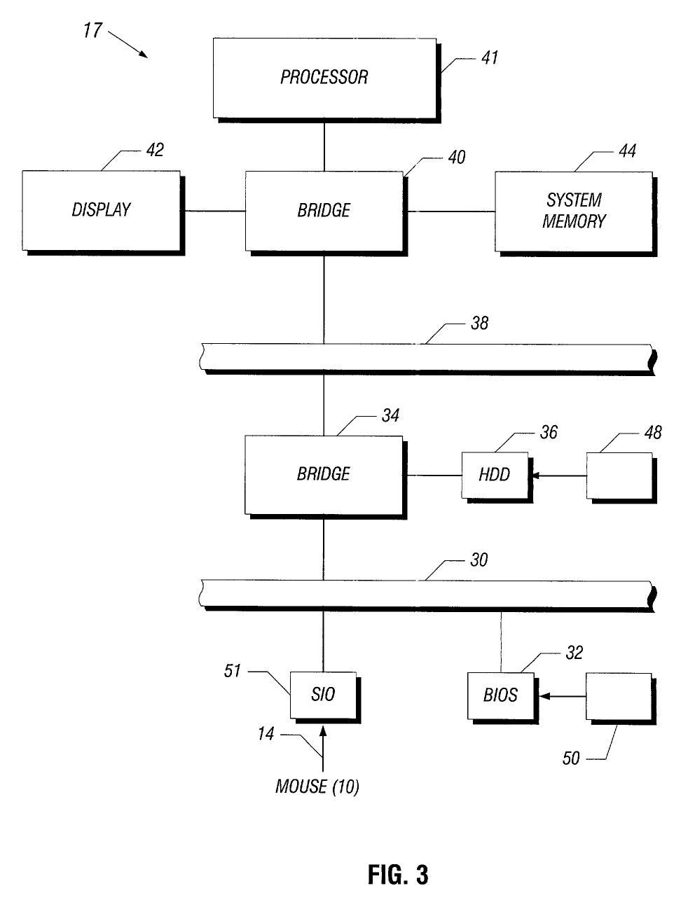

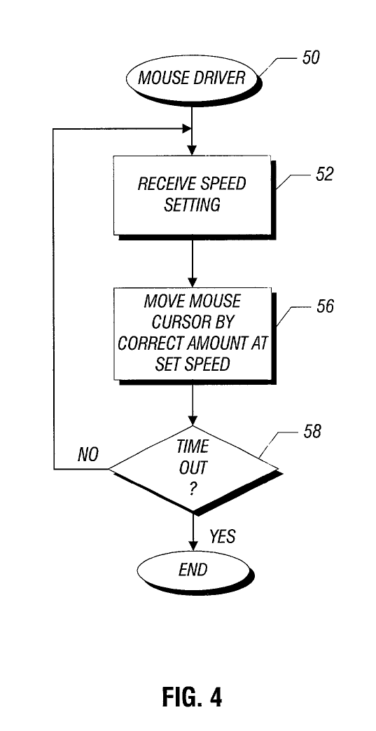

As shown in FIG. 3, a processor-based system 17 may receive the cable 14 via a serial input/output (SIO) device 51 in one embodiment. The SIO device 51 may be coupled to a bus 30 that is also coupled to a basic input/output system (BIOS) memory 32 in one implementation. The memory 32 may include a software program 50 described hereinafter.

In one implementation, the bus 30 may be coupled to a bridge 34. The bridge 34 may include a connection to a hard disk drive 36 that may store software 48.

Of course, a variety of different processor-based system architectures may be utilized in connection with the present invention. The exact design of the processor-based system 17 is of no particular significance to the present invention and is provided merely for illustration purposes.

In one embodiment, the bridge 34 is coupled to a second bus 38, in turn, coupled to a bridge 40. The bridge 40 may be coupled to a processor 41 as well as a system memory 44 and a display 42. Conventionally, an on-screen cursor moves on the display 42 in response to movements of the pointing device 10.

Software 48 or 50 for enabling the speed of cursor movements to be manually controlled through the use of the control 16 may be stored in a variety of storage devices on the processor-based system 17. For example, initially, the software 48 may be stored on the hard disk drive 36 or the software 50 may be stored on the BIOS memory 32. The BIOS memory 32 may be a read only memory (ROM) or a flash memory, as two examples.

The driver software 48 or 50 may receive a speed command as indicated in block 52 from the control 16 through the interface 28. In one embodiment, the speed setting may be received as an non-maskable interrupt (NMI). When received, a mouse cursor command may be generated to move the cursor image by the distance indicated by pointing device 10 movement, at the determined speed (received from the control 16), as indicated in block 56. Thus, the user's ongoing cursor speed commands may be received together with information about the movement of the pointing device 10 to allow the speed at which the onscreen cursor image moves in response to mouse movements to be adjusted “on-the-fly”.

A check at diamond 58 indicates whether a “time out” has occurred. If so, the flow may end. Otherwise, the flow may continue to receive mouse cursor commands together with mouse speed commands and adjust the rate of movement of the cursor as desired by the user.

In a number of cases, the user may manually adjust the speed at which the user is able to input data by moving the on-screen cursor at a higher speed or conversely a lower speed if that is desired. In game play, this may make the user much more agile. In cases where more complex mouse cursor movements are needed, the user can slow down the rate of cursor movement to avoid overrunning the desired targets and otherwise wasting time because of over aggressive cursor positioning.

While a pointing device 10 for a person who is right handed is illustrated, a left handed version may have the control 16 on the opposite side of the wall 13.

While the present invention has been illustrated in connection with a mouse, any pointing device may be modified to include the control 16. Other pointing devices include track balls, pointing sticks, touch pads, and joy sticks, as examples.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A pointing device comprising:
a pointing device body including an element to detect movement of the body; and
a control to enable the user to manually change the rate at which a cursor image moves in response to movement of said body.

2. A device of claim 1 wherein said pointing device is a mouse.

3. The pointing device of claim 2 wherein said mouse includes a body having a curved upper surface and a peripheral side wall, said control being positioned on said side wall.

4. The pointing device of claim 2 wherein said control is positioned on said mouse so as to be operable by the user's thumb when the user's hand is on top of the mouse.

5. The pointing device of claim 1 wherein said control is a roller switch.

6. The pointing device of claim 1 wherein said control enables the rate at which the cursor image moves to be manually increased or decreased.

7. A mouse comprising:
a body including an element to detect movement of the body; and
a control to enable the user to manually change the rate at which a cursor image moves in response to movement of said body, said control being positioned to lie under the user's thumb when the body is positioned in the user's hand.

8. The mouse of claim 7 wherein said body includes a curved upper surface and a side wall, said control being positioned in said side wall.

9. The mouse of claim 7 wherein said control is a roller switch.

10. The mouse if claim 7 wherein said control enables the rate at which the cursor image moves to be manually increased or decreased.

11. A method comprising:
enabling a mouse to generate position signals; and
enabling a mouse to receive manual input commands to alter the rate of movement of an on-screen cursor.

12. The method of claim 11 including receiving signals from a control mounted on a mouse and a response thereto, selectively increasing or decreasing the rate of movement of on-screen cursor.

13. A pointing device comprising:
a first element to generate pointing device position signals; and
a second device attached to the first device to provide cursor speed control signals.

14. The pointing device of claim 13 wherein said pointing device is a mouse.

15. The pointing device of claim 14 including a mouse body having a curved upper surface and a peripheral side wall, a roller switch being positioned in said side wall, said roller switch operable to increase or decrease the speed of cursor movement.
